(19) United States
(12) Patent Application Publication
(10) Pub. No.: US 2026/0265024 A1
(43) Pub. Date: Sep. 10, 2026

(54) WORK VEHICLE

(71) Applicant: TADANO LTD., Kagawa (JP)

(72) Inventors: Mizuki YONEDA, Kagawa (JP); Yota MATSUOKA, Kagawa (JP)

(73) Assignee: TADANO LTD., Kagawa (JP)

(21) Appl. No.: 19/489,270

(22) PCT Filed: Jun. 11, 2024
(86) PCT No.: PCT/JP2024/021181

§ 371 Date: Dec. 2, 2025

(30) Foreign Application Priority Data
Jun. 14, 2023 (JP) 2023-097430

(51) Int. Cl. B66C 13/16; B66C 23/90; G06T 7/593; G06T 7/60; G06V 10/12; G06V 10/60; G06V 20/56

(52) U.S. Cl. CPC B66C 13/16; B66C 23/905; G06T 7/593; G06T 7/60; G06V 10/12; G06V 10/60; G06V 20/56; G06T 2207/10012; G06T 2207/30252

(57) ABSTRACT

This work vehicle includes a visual recognition unit having an imaging function and a distance detection function, and a control unit that controls a crane device. The control unit calculates the estimated weight of a suspended load on the basis of information relating to an image of the suspended load that has been captured by the visual recognition unit and the distance to the suspended load that has been detected by the visual recognition unit.

### TECHNICAL FIELD

The present invention relates to a work vehicle.

### BACKGROUND ART

For work vehicles used in construction sites, techniques for supporting an operation of an operator and corresponding to automation have been actively developed. Patent Literature 1 discloses a technique related to a construction machine control system that supports an operation of an operator. Such a construction machine control system includes an imaging device that captures an image of a suspended load carried by a work vehicle (specifically, a crane vehicle). Then, the construction machine control system recognizes a size of the suspended load on the basis of the image of the suspended load captured by the imaging device and data accumulated in a learning machine.

### CITATION LIST

### Patent Literature

Patent Literature 1: JP 2020-37475 A

### SUMMARY OF THE INVENTION

### Problems to be Solved by the Invention

By the way, in the work vehicle as described above, it is desirable that the weight of the suspended load can be accurately estimated.

An object of the present invention is to provide a work vehicle capable of accurately estimating the weight of a suspended load.

### Solutions to Problems

One aspect of a work vehicle according to the present invention includes a visual recognition unit having an imaging function and a distance detection function, and a control unit that controls a crane device, in which the control unit calculates the estimated weight of a suspended load on the basis of an image of the suspended load that has been captured by the visual recognition unit and information relating to a distance to the suspended load that has been detected by the visual recognition unit.

According to the present invention, it is possible to provide the work vehicle capable of accurately estimating the weight of the suspended load.

### BRIEF DESCRIPTION OF DRAWINGS

FIG. 1 is a control flow chart of a work vehicle according to an embodiment of the present invention.

FIG. 2 is a side view of the work vehicle according to the embodiment of the present invention.

FIG. 3 is a hydraulic circuit diagram of the work vehicle in FIG. 2.

FIG. 4 is a control circuit diagram of the work vehicle of FIG. 2.

FIG. 5 is an example of an image obtained by capturing the ground from the visual recognition device of the work vehicle in FIG. 2.

### DESCRIPTION OF EMBODIMENTS

Next, an embodiment of the present invention will be described with reference to the drawings. However, the following embodiment is an example for embodying the technical idea of the present invention, and the present invention is not limited to the following embodiment. In addition, sizes, positional relationships, and the like of members illustrated in the drawings may be exaggerated for clarity of description.

### Embodiment

### Mobile Crane

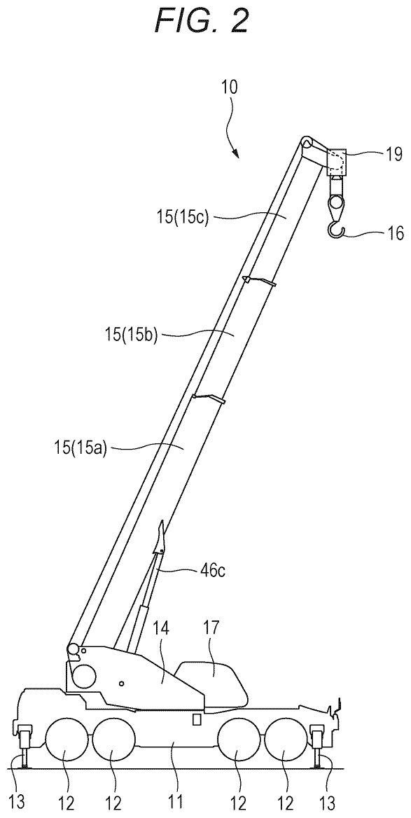

FIG. 2 is a side view of a mobile crane 10 which is a work vehicle according to the present embodiment. The mobile crane 10 includes a motor and a plurality of wheels 12 provided on a traveling vehicle body 11 for traveling. In addition, the mobile crane 10 includes an outrigger 13 that ensures stability during a crane operation. A swivel base 14 is mounted on an upper surface of the traveling vehicle body 11. The swivel base 14 can turn 360° in the horizontal plane by a swivel motor. The swivel base 14 is provided with a cab 17 in which an operator of the mobile crane 10 rides. Hereinafter, in the description of the mobile crane 10, a front-rear direction means a front-rear direction in a state in which the mobile crane 10 can travel unless otherwise specified. In addition, a left-right direction means a left-right direction when the mobile crane 10 is viewed from the rear of the mobile crane 10 unless otherwise specified. Further, an up-down direction means an up-down direction in a state in which the mobile crane 10 can travel.

A slip ring and a swivel joint are provided between the traveling vehicle body 11 and the swivel base 14. The slip ring connects an electrical system between the traveling vehicle body 11 and the swivel base 4. In addition, the swivel joint connects an air system and a hydraulic system between the traveling vehicle body 11 and the swivel base 4. In this specification, the mobile crane 10 is divided into the traveling vehicle body 11 and a crane device mounted on the traveling vehicle body 11 with the slip ring and the swivel joint interposed therebetween. That is, the crane device includes the swivel base 14, a boom 15, and the like.

The boom 15 is mounted on the swivel base 14 so as to be raised and lowered. The boom 15 includes a plurality of components. The components correspond to a main boom 15a on a proximal end side and a plurality of stages of sub-booms telescopically inserted into the main boom 15a.

In the present embodiment, the sub-booms include a first sub-boom 15b located on the proximal end side and a second sub-boom 15c located on a distal end side. The number of sub-booms is two in the illustrated example, but may be one or less or three or more. An extension/retraction operation of each of the sub-booms 15b and 15c is performed by a cylinder provided in the boom 15. In the present embodiment, the boom component located at the most distal end is the second sub-boom 15c.

A proximal end of the boom 15 is pivotally supported by the swivel base 14. A boom derricking actuator 46c is attached between the boom 15 and the swivel base 14. When the boom derricking actuator 46c extends, the boom 15 is raised. In addition, when the boom derricking actuator 46c contracts, the boom 15 is lowered.

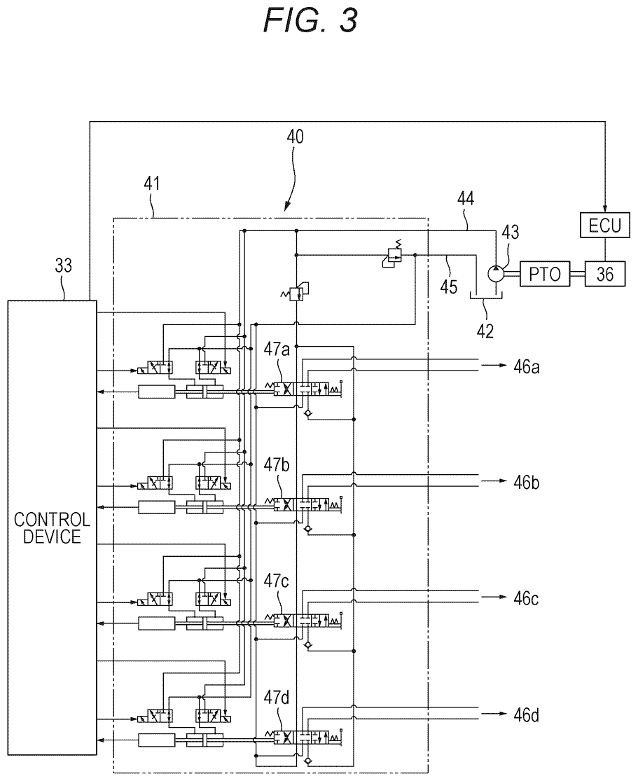

A wire rope including a hook 16 is suspended from a boom head provided at a distal end of the boom 15. The wire rope is guided to the root of the boom 15 along the boom 15 and wound around a winch. The winch is provided with a winch hydraulic motor 46b (see FIG. 3). When the winch hydraulic motor 46b is driven to rotate the winch, the wire rope is wound up or unwound. As a result, the hook 16 is moved up or down. As described above, combination of the extension, retraction, and derricking of the boom 15 and the vertical movement of the hook 16 allows the mobile crane 1 to lift and lower a load in a three-dimensional space.

In the present embodiment, a visual recognition device 19 is provided on a distal end side of the second sub-boom 15c. The visual recognition device 19 corresponds to an example of a visual recognition unit, and has an imaging function of capturing an image of a suspended load placed on the ground or the like and a distance detection function of detecting a distance to the suspended load.

Since the visual recognition device 19 is provided on the boom component located at the most distal end, the suspended load can be visually recognized by turning the boom above a position where the suspended load is placed. That is, the visual recognition device 19 can recognize the suspended load placed below the visual recognition device 19. This makes it easier for a control device 33 to recognize the suspended load.

In the present embodiment, the visual recognition device 19 includes two devices. A first device of the two devices is an imaging device having the function of capturing the image of the suspended load. The second device is a distance measuring device that detects the distance to the suspended load. The distance measuring device corresponds to, for example, laser imaging detection and ranging (LIDAR).

In the case of the present embodiment, the visual recognition device 19 can be configured by combining the distance measuring device with the imaging device conventionally adopted in many models, so that the cost of the visual recognition device 19 can be suppressed. In addition, since the imaging device and the distance measuring device can be separately selected, the range of device selection can be expanded.

Note that the visual recognition device 19 is not limited to the above configuration. For example, the visual recognition device 19 may be a stereo camera having the function of capturing the image of the suspended load and the function of measuring the distance to the suspended load.

When the visual recognition device 19 is the stereo camera having the two functions, it is easy to secure a space for the visual recognition device 19.

### Hydraulic Circuit 40

FIG. 3 is a hydraulic circuit diagram of the mobile crane 10 according to the present embodiment. As illustrated in FIG. 3, a hydraulic circuit 40 of the crane device includes a hydraulic valve unit 41, a hydraulic pump 43, a main oil passage 44, a return oil passage 45, and a plurality of crane device actuators 46a to 46d.

The hydraulic pump 43 supplies a hydraulic oil in a tank 42 to the hydraulic valve unit 41. The main oil passage 44 connects the hydraulic pump 43 and the hydraulic valve unit 41. The return oil passage 45 connects the hydraulic valve unit 41 and the tank 42. The T plurality of crane device actuators 46a to 46d perform the extension/retraction operation of the boom 15, winding-up of the winch, unwinding of the winch, the derricking operation of the boom 15, the turning operation of the boom 15, and the like. The crane device actuators 46a to 46d are connected to the hydraulic valve unit 41.

The hydraulic pump 43 is connected to an engine 36 of the traveling vehicle body 11 via a power take-off (PTO) device. The hydraulic pump 43 is driven by the engine 36.

The hydraulic valve unit 41 includes a boom extension/retraction control valve 47a, a winch control valve 47b, a boom derricking control valve 47c, and a boom turning control valve 47d. The boom extension/retraction control valve 47a is connected to a boom expansion/retraction actuator 46a. The winch control valve 47b is connected to the winch hydraulic motor 46b. The boom derricking control valve 47c is connected to the boom derricking actuator 46c. The boom turning control valve 47d is connected to a boom turning actuator 46d.

A lever is attached to each of these control valves. The operator manually operates the lever to switch the direction and flow rate of the hydraulic oil supplied from the hydraulic pump 43.

In addition, the control device 33 is also connected to an engine control unit (ECU) of the engine 36. The control device 33 controls at least the rotation speed of the engine 36. The control device 33 controls the rotation speed of the hydraulic pump 43 by controlling the rotation speed of the engine 36. In this manner, the control device 33 adjusts a discharge amount of the hydraulic pump 43.

### Control Circuit

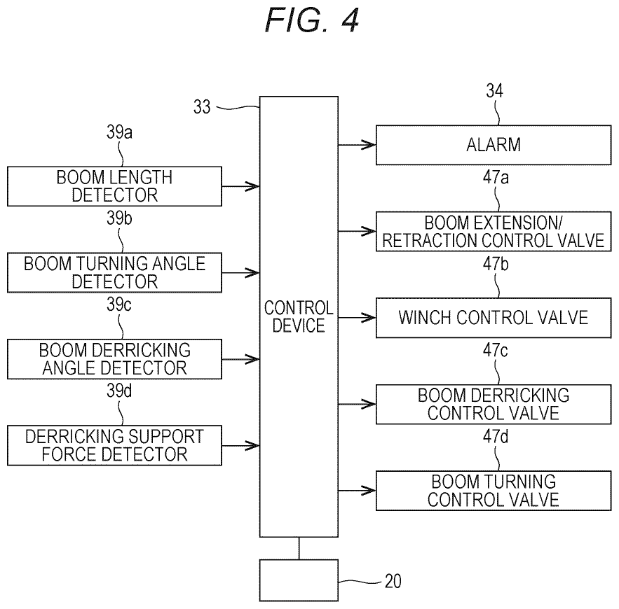

FIG. 4 is a diagram illustrating a control circuit diagram of the mobile crane 10 according to the present embodiment. A boom length detector 39a, a boom turning angle detector 39b, a boom derricking angle detector 39c, and a derricking support force detector 39d are electrically connected to an input side of the control device 33. In addition, an alarm 34, the boom extension/retraction control valve 47a, the winch control valve 47b, the boom derricking control valve 47c, and the boom turning control valve 47d are electrically connected to an output side of the control device 33. In addition, an input/output device 20 including a work screen 21 is electrically connected to the control device 33.

The boom length detector 39a detects the length of the boom 15. The boom length detector 39a is, for example, a cord feed-out length detector. The cord feed-out length detector detects a feed-out length of a cord for length measurement by detecting a rotational displacement amount of a cord winder.

The boom turning angle detector 39b detects a turning angle of the boom 15. The boom turning angle detector 39b is disposed on a base side of the swivel base 14. For example, the boom turning angle detector 39b is a potentiometer. As the boom turning angle detector 39b, a rotary encoder may be used instead of the potentiometer.

The boom derricking angle detector 39c detects a derricking angle of the boom 15. The boom derricking angle detector 39c is disposed on the base side of the boom 15. For example, the boom derricking angle detector 39c is a potentiometer. As the boom derricking angle detector 39c, a rotary encoder may be used instead of the potentiometer.

The derricking support force detector 39d detects the load suspended on the hook 16. In the present embodiment, the derricking support force detector 39d is a differential pressure gauge provided in a boom derricking cylinder. The derricking support force detector 39d sends the detected differential pressure to the control device 33.

In a predetermined status, the alarm 34 notifies the operator of the mobile crane 10 of the status (In other words, an operation status). The predetermined status is, for example, a status in which the suspended load exceeds the rated load. As a result, the operator can recognize that the mobile crane 10 is in the predetermined status. In the present embodiment, the alarm 34 is provided outside the cab 17.

### Control Flow

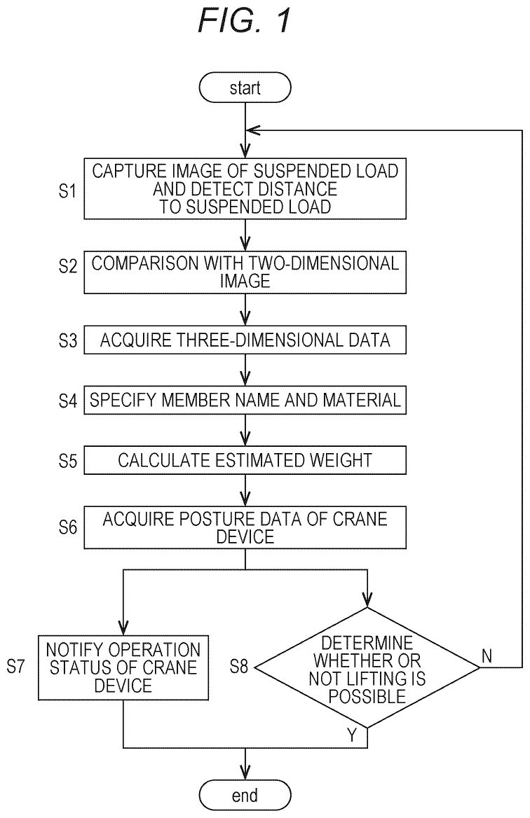

FIG. 1 is a control flow chart of the work vehicle according to the present embodiment. This control flow chart is a control flow chart when the operator of the mobile crane 10 rides on the cab 17 and performs an operation of suspending the suspended load. Before performing this operation, the control device 33 uses its learning function to perform learning regarding a plurality of members to be suspended loads. For example, the control device 33 repeats learning by taking in CAD data of a suspended load or physical data such as a material (density) of the member, and creates three-dimensional data of the suspended load by rendering. Then, from the three-dimensional data, a plurality of two-dimensional images that may be plan views of the suspended load are created. The control device 33 accumulates the two-dimensional image of the member to be the suspended load, a member name, the material (density), and the like in a suspended load database (not illustrated) by the learning function. The suspended load database stores the two-dimensional images of the member to be the suspended load, the member name, and the material (density) in association with the three-dimensional data of the suspended load.

In step S1 of the control flow, the control device 33 captures an image of a suspended load using the visual recognition device 19 and detects information on the distance from the visual recognition device 19 to the suspended load (hereinafter, simply referred to as “information relating to the distance of the suspended load”). Note that the control device 33 corresponds to an example of a control unit. At this time, the suspended load is placed, for example, on the ground or the like present below the visual recognition device 19. The visual recognition device 19 has the function of capturing the image of the suspended load and the function of detecting the information relating to the distance of the suspended load, and thus, captures the image of the suspended load and detects the information relating to the distance of the suspended load according to an instruction from the control device 33. The visual recognition device 19 sends the detected image of the suspended load and the information relating to the distance of the suspended load to the control device 33. The control device 33 acquires information relating to a shape of the suspended load on the basis of the image of the suspended load acquired from the visual recognition device 19. In addition, the control device 33 acquires information relating to a size of the suspended load by detecting distances of a large number of points on the surface of the suspended load on the basis of the information relating to the distance of the suspended load acquired from the visual recognition device 19. The information relating to the size of the suspended load may be, for example, information indicating a scale (dimension) of the suspended load.

Next, in step S2 of FIG. 1, the control device 33 refers to the suspended load database and compares a two-dimensional image stored in the suspended load database with the image of the suspended load included in the image captured by the visual recognition device 19 (hereinafter, simply referred to as a “suspended load image”). Then, the control device 33 acquires the two-dimensional image corresponding to the suspended load image from the suspended load database.

Next, in step S3 of FIG. 1, the control device 33 acquires three-dimensional data (in other words, information relating to the shape of the suspended load) of. the suspended load corresponding to the two-dimensional image acquired in step S2 from the suspended load database. In addition, the control device 33 confirms that an accurate size of the suspended load matches the three-dimensional data by the function of detecting the distance to the suspended load.

Next, in step S4, the control device 33 specifies a material (density). In step S4, the control device 33 may specify a member name of the suspended load. Specifically, the control device 33 acquires the material (density) associated with the three-dimensional data specified in step S3. The material (density) corresponds to an example of physical data. In addition, the control device 33 may acquire the member name of the suspended load associated with the three-dimensional data specified in step S3.

In step S5, the control device 33 calculates the estimated weight of the suspended load on the basis of the three-dimensional data (in other words, the information relating to the shape of the suspended load) specified in step S3, the material (density) acquired in step S4, and the information (in other words, the scale of the suspended load) relating to the size of the suspended load acquired in step S1.

In step S6, the control device 33 acquires posture data of the crane device. This posture data is acquired from the boom length detector 39a, the boom turning angle detector 39b, and the boom derricking angle detector 39c.

In step S7, the control device 33 notifies the operator of the mobile crane 10 of the operation status of the crane device. As a method for the notification, for example, in a case where it is impossible to lift the suspended load due to the rated load of the mobile crane 10, the control device 33 issues a warning sound in a method set in advance by the alarm 34, displays that the rated load is exceeded on a screen of the input/output device 20 such as a touch panel, or displays how close the traveling vehicle body 11 is preferably brought to the suspended load.

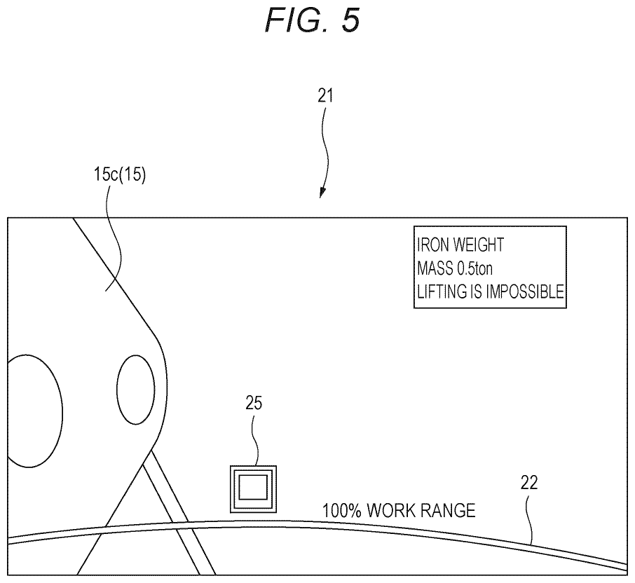

In step S8, the control device 33 determines whether or not the crane device can lift the suspended load on the basis of the estimated weight and the posture data of the crane device, and notifies the determination result. FIG. 5 is a view illustrating an example of a work screen 21 on which the ground is captured from the visual recognition device 19 of the mobile crane 10 of the present embodiment. On the work screen 21, the distal end of the second sub-boom 15c is displayed on the left side, and a suspended load 25 having a rectangular shape is displayed. The suspended load 25 is a suspended load placed at a predetermined position. That is, the suspended load 25 is not yet suspended by the mobile crane 10. For example, the control device 33 displays the estimated weight of the suspended load 25 on the upper right of the work screen 21, acquires the posture data of the crane device, and displays “lifting is impossible” as the operation status of the crane device. In addition, a limit curve 22 indicating a work range of the crane device may be displayed on the work screen. The operator of the mobile crane 10 estimates a distance between the limit curve 22 and the rectangular suspended load 25. Then, the operator determines how close the traveling vehicle body 11 needs to be brought to the suspended load 25 in order to lift the suspended load 25. In addition, the control device 33 may calculate a distance by which the traveling vehicle body 11 is brought close to the suspended load 25 in order to lift the suspended load 25, and display the calculated distance on the work screen 21. In step S8, when the control device 33 determines that lifting is possible, the control device 33 performs display indicating that lifting is possible. On the other hand, when the control device 33 determines that the lifting is impossible in step S8, the control device 33 notifies this fact. Then, the control device 33 returns the control processing to step S1 and repeats this control flow.

Since the visual recognition device 19 is provided on the work vehicle, it is not necessary to separately provide an imaging device or the like in addition to the work vehicle. This makes it easy for the control device 33 to recognize the suspended load. In addition, the estimated weight of the suspended load can be calculated by associating the physical parameter (specifically, the density of the suspended load) with the three-dimensional data corresponding to the suspended load, and the operation status of the crane device can be confirmed before actually lifting the suspended load. That is, the control illustrated in FIG. 1 is performed before the crane device lifts the suspended load.

In addition, in the case of the present embodiment, it is determined whether or not the crane device can lift the suspended load on the basis of the estimated weight and the posture data of the crane device. Then, the operator is notified of the determination result. Therefore, the operator can know whether or not the suspended load can be lifted before starting a lifting operation. As a result, the operator can determine in advance whether or not a work place of the work vehicle is appropriate, so that the work efficiency is improved.

### Others

Note that description has been given regarding a configuration in which the visual recognition device 19 is provided on the boom component located at the most distal end, that is, the second sub-boom 15c among the boom components constituting the boom 15 in the mobile crane 10 described above, but the present invention is not limited to this configuration. For example, it is also possible to provide the visual recognition device 19 on a body of the mobile crane 10 such as the swivel base 14. In this case, when the visual recognition device 19 includes an imaging device and a distance measuring device, either one can be provided on the swivel base 14. Note that the description “including the visual recognition device 19” in the claims means that the visual recognition device is provided at any place of a body of a work vehicle such as the mobile crane 10.

In addition, it is preferable that the distance measuring device constituting the visual recognition device 19 has a function of measuring a reflection intensity of the suspended load. In this case, it is also possible for the control device 33 to estimate a density of the suspended load on the basis of the measured reflection intensity and to use this estimated density as a physical parameter.

Since the density of the suspended load estimated on the basis of the reflection intensity of the suspended load is used as the physical parameter, it is possible to omit time and effort for manually inputting the physical parameter. In addition, the operator of the work vehicle can confirm whether or not the estimated density matches manually input data.

### Supplementary Note

A work vehicle according to a first example of a reference example of the present invention includes:
a visual recognition device having a function of capturing an image of a suspended load and a function of detecting a distance to the suspended load;
a crane device for lifting the suspended load; and
a control device that controls the crane device,
in which the control device
acquires three-dimensional data corresponding to the suspended load recognized by the visual recognition device,
associates the three-dimensional data with a physical parameter to calculate an estimated weight of the suspended load, and
notifies an operation status of the crane device on the basis of the estimated weight.

A work vehicle according to a second example of the reference example of the present invention that cites the first example of the reference example described above may be configured such that
the control device notifies whether or not the crane device can lift the suspended load on the basis of the estimated weight and posture data of the crane device.

A work vehicle according to a third example of the reference example of the present invention that cites the first example of the reference example described above may be configured such that
the visual recognition device is provided on a boom component located at the most distal end among boom components constituting a boom of the crane device.

A work vehicle according to a fourth example of the reference example of the present invention that cites the first example of the reference example described above may be configured such that
the visual recognition device includes an imaging device having the function of capturing the image of the suspended load and a distance measuring device that detects the distance to the suspended load.

In a work vehicle according to a fifth example of the reference example of the present invention that cites the first example of the reference example described above,
the visual recognition device may be configured by a stereo camera having the function of capturing the image of the suspended load and a function of measuring the distance to the suspended load.

A work vehicle according to a sixth example of the reference example of the present invention that cites the first example of the reference example described above may be configured such that
the distance measuring device has a function of measuring a reflection intensity of the suspended load, and the control device estimates a density of the suspended load on the basis of the reflection intensity and uses this estimated density as a physical parameter.

This application is based upon and claims the benefit of priority from Japanese Patent Application No. 2023-97430, filed on Jun. 14, 2023, the entire contents of which are incorporated herein by reference.

### INDUSTRIAL APPLICABILITY

The work vehicle according to the present invention may be various crane vehicles.

### REFERENCE SIGNS LIST

10 Mobile crane (work vehicle)
15 Boom
19 Visual recognition device
33 Control device

1. A work vehicle comprising:
a visual recognition unit having an imaging function and a distance detection function; and
a control unit that controls a crane device,
wherein the control unit calculates an estimated weight of a suspended load on a basis of an image of the suspended load that has been captured by the visual recognition unit and information relating to a distance to the suspended load that has been detected by the visual recognition unit.

2. The work vehicle according to claim 1, wherein
the control unit
acquires information relating to a shape of the suspended load and information relating to a material of the suspended load on the basis of the image of the suspended load,
acquires information relating to a size of the suspended load on the basis of the information relating to the distance, and
calculates the estimated weight on the basis of the information relating to the shape, the information relating to the material, and the information relating to the size.

3. The work vehicle according to claim 2, wherein
the control unit
includes a suspended load database that stores pieces of three-dimensional data of various types of suspended loads in association with two-dimensional images of the suspended loads and materials of the suspended loads, respectively,
acquires, from the suspended load database, information relating to a shape of the suspended load and information relating to a material of the suspended load associated with a two-dimensional image of the suspended load on the basis of the image of the suspended load, and
calculates the estimated weight on the basis of the information relating to the shape and the information relating to the material acquired from the suspended load database, and the information relating to the size acquired on the basis of the information relating to the distance.

4. The work vehicle according to claim 1, wherein
the control unit notifies an operation status of the crane device on a basis of the estimated weight.

5. The work vehicle according to claim 1, wherein
the visual recognition unit is provided on a boom of the crane device, and
the image of the suspended load is an image of the suspended load placed below the visual recognition unit.

6. The work vehicle according to claim 4, wherein
the image of the suspended load is an image of the suspended load placed below the visual recognition unit, and
the control unit
determines whether or not the crane device is capable of lifting the suspended load on the basis of the estimated weight and posture data of the crane device, and
notifies a determination result as the operation status.

7. The work vehicle according to claim 1, wherein
the visual recognition unit includes
an imaging device having the imaging function, and
a distance measuring device having the distance detection function.

8. The work vehicle according to claim 2, wherein
the visual recognition unit has a function of measuring a reflection intensity of the suspended load, and
the control unit estimates a density as the information relating to the material on a basis of the reflection intensity.

9. The work vehicle according to claim 1, wherein
the visual recognition unit is a stereo camera.
